(19) United States
(12) Patent Application Publication
(10) Pub. No.: US 2006/0059175 A1
(43) Pub. Date: Mar. 16, 2006

(54) Computer operation recording program, computer operation solving program, computer, management apparatus, and method

(75) Inventors: Akihiro Shimaya, Kawasaki (JP); Tatsuya Kita, Kawasaki (JP); Kouji Shimizu, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/992,015

(22) Filed: Nov. 19, 2004

(30) Foreign Application Priority Data
Aug. 27, 2004 (JP) 2004-248794

(51) Int. Cl. G06F 7/00

(52) U.S. Cl. 707/100

(57) ABSTRACT

A computer operation recording program causes a computer to execute the steps of: recording image information of a display screen, which is outputted from the computer, at a predetermined time interval in accordance with a predetermined user's operation when a malfunction occurs in the computer taken as a trigger; creating report information which includes the image information and reports the malfunction; transmitting the report information to a management apparatus; and receiving, from the management apparatus, response information in which information on a countermeasure against the malfunction reported by the report information is stored.

### BACKGROUND OF THE INVENTION

The present invention relates to a technology for solving a malfunction of an application program executed by a computer.

In a computer used by a common user, application programs for causing the computer to execute various processing are installed. In particular, such an application program for utilizing so-called Web site information or a Web site service as to execute information communication through the Internet (for example, a browser program which communicates with a server on a network by means of HTTP (HyperText Transfer Protocol) is used in many computers.

Heretofore, when a malfunction occurs in any of the application programs installed in the computer, the user may be liable to inquire of a manufacturer of the computer or the application program (hereinafter, referred to as “maker”) and attempts to solve the malfunction.

Note that as prior arts relating to the invention of this application, for example, there are technologies disclosed in the following Patent documents 1 to 9.

[Patent document 1] JP 05-040593 A

[Patent document 2] JP 2003-256108 A

[Patent document 3] JP 2004-030005 A

[Patent document 4] JP 02-041531 A

[Patent document 5] JP 07-295714 A

[Patent document 6] JP 06-051888 A

[Patent document 7] JP 2000-076266 A

[Patent document 8] JP 2002-149233 A

[Patent document 9] JP 2003-319088 A

Incidentally, it has been common that the maker's side requires detailed information regarding the malfunction from the user in order to solve the malfunction of the application program of the computer as described above.

However, in such a case, it has not been easy to transmit accurate and detailed information from the user to the maker's side.

Specifically, when the malfunction of the application program occurs, the user contacts a support center of the maker, for example, by telephone or the like. A support person in the maker attempts to drag the detailed information of the malfunction out of the user. At this time, there have been many cases where the user who is not a specialist of the computer tells information explaining a fragmentary and abstract phenomenon regarding the malfunction (for example, an error message comes out when a certain Web page is displayed) by word of mouth. It has been common that the support person of the maker attempts to solve the malfunction based on such information from the user.

Hence, according to a conventional common method of solving the malfunction of the application program, it has been difficult to accurately grasp the detailed information of the malfunction which has occurred on the user's side. Moreover, according to the conventional common method of solving the malfunction of the application program, it has been difficult to solve the malfunction rapidly and surely because it has been difficult to accurately grasp the malfunction which has occurred.

### SUMMARY OF THE INVENTION

The present invention is one made in consideration of the matters. Specifically, an object of the invention is to provide a technology for assisting to rapidly and surely solve the malfunction which has occurred in the computer.

In order to achieve the object, the present invention is made as the following means.

Specifically, the present invention is made to provide a computer operation recording program for causing a computer to execute the steps of:

recording image information of a display screen, which is outputted from the computer, at a predetermined time interval with a predetermined user's operation when a malfunction occurs in the computer taken as a trigger;

creating report information which includes the image information and reports the malfunction;

transmitting the report information to a management apparatus; and

receiving, from the management apparatus, response information in which information on a countermeasure against the malfunction reported by the report information is stored.

According to the present invention, the image information on the display screen, which is outputted from the computer, is recorded at the predetermined time interval with the predetermined user's operation when the malfunction occurs in the computer taken as the trigger. Therefore, it is possible to record the malfunction accurately and objectively, and can transmit the malfunction to the management apparatus by the report information. Moreover, the present invention allows the reception of the response information in which the information of the countermeasure is stored as a response to the report information including the image. Accordingly, the present invention can acquire a countermeasure handling the malfunction accurately.

The computer operation recording program may further cause the computer to execute the step of creating motion picture information from a start of recording to an end of the recording based on the image information, wherein the motion picture information may be stored in the report information. According to the present invention, the motion picture is created from a series of the recorded images, so that a phenomenon of the malfunction can be virtually reproduced on the management apparatus side with the elapse of time.

The report information may include, for example, information relating to the computer. In the information relating to the computer, information specifying a model of the computer, information specifying performance of the computer, information controlling an operating state of the computer, or information specifying an operating system introduced into the computer may be included. According to the present invention, the report information includes the information relating to the computer, thereby making it possible to assist sure creation of the countermeasure against the malfunction.

Moreover, the report information may include, for example, information relating to an application program executed by the computer. In the information relating to the application program, a name of the application program or version information on the application program may be included. According to the present invention, the report information includes the information relating to the application program executed by the computer, thereby making it possible to assist the sure creation of the countermeasure against the malfunction.

This computer operation program may further cause the computer to execute the step of transmitting, to the management apparatus, result information as to whether or not the malfunction has been solved as a result of application of the countermeasure. According to the present invention, whether or not the countermeasure has been effective is transmitted to the management apparatus, thereby making it possible to assist accumulation of actual results of the effective countermeasures against reports on the malfunctions in the management apparatus.

Moreover, the present invention is made to provide a computer operation solving program for causing a computer to execute the steps of:

receiving, from a user's computer on a network, report information reporting a malfunction which has occurred in the user's computer;

searching a report database, which stores the past report information and information of a countermeasure against the contents of the report reported in the past report information, for past report information similar to contents of the report information; and

transmitting, to the user's computer, the information on the countermeasure against the past report information retrieved from the report database.

According to the present invention, the report database, which stores the past report information and the information of the countermeasure against the contents of the report reported in the past report information, is searched for the past report information similar to the contents of the report information. Then, the information of the countermeasure against the contents of the report is transmitted to the user's computer, thereby making it possible to provide an effective countermeasure based on the past actual results to the user's computer.

The report information may include image information relating to the malfunction, and the computer operation solving program may further cause the computer to execute the steps of:

calculating a degree of coincidence indicating an extent of coincidence by comparing the image information stored in the report information and image information in the past report information stored in the report database with each other; and

extracting past report information in which the degree of coincidence satisfies a predetermined range. According to the present invention, the past report information similar to the contents of the report information is searched for based on whether or not the image information relating to the malfunction coincides with each other within the predetermined range. Then, the past report information showing coincidence within the predetermined range is extracted, thereby making it possible to extract an actual result of the countermeasure or a history of the countermeasure against the past malfunction objectively similar to the malfunction in terms of a phenomenon.

Moreover, the present invention is made to provide a method of causing a computer, another apparatus, a machine, or the like, which has a communication function, to execute any of the processings described above. Moreover, the present invention may be one in which such a program is recorded in a recording medium readable by the computer, the other apparatus, machine, or the like. Moreover, the present invention may be the computer, the other apparatus, machine, or the like having the communication function, which include means for executing any of the processings described above.

### DESCRIPTION OF THE DRAWINGS

FIG. 1 is a block diagram showing a functional configuration of a computer according to an embodiment.

FIG. 2 is a block diagram showing a functional configuration of a server according to the embodiment.

FIG. 3 is a flowchart showing processing of a failure report by a malfunction solving system realized by the computer and the server.

FIG. 4 is a view showing a creation process of a failure report file according to the embodiment.

FIG. 5 is a view showing an example of processing for failure reports to a support system on a maker's side managing the server according to the embodiment.

FIG. 6 is a flowchart showing processing for failure solution by the malfunction solving system realized by the computer and the server.

FIG. 7 is a view showing an example of reporting processing to a person in charge of the support system after transmission of a malfunction solving case to the computer.

FIG. 8 is a view showing an example of processing according to the system after a response file is created by the support person for a new failure.

### DETAILED DESCRIPTION OF THE INVENTION

A best mode of carrying out the present invention is described below with reference to the drawings. A configuration of the following embodiment is illustrative, and the present invention is not limited to the configuration of the embodiment. In this embodiment, a program of the present invention for solving a malfunction of a computer includes a computer operation recording program which operates on a user's computer that is a client apparatus, and a computer operation solving program which operates on a server (corresponding to the management apparatus of the present invention) which provides the client apparatus with information or a service.

The computer operation recording medium is introduced (installed) into the user's computer. The computer operation recording program is executed by the computer, thereby collecting information on a malfunction which has occurred in the computer. Then, the computer operation recording program transmits the information on the malfunction to the server provided in a support center on a maker's side. Then, the server executes the computer operation solving program, performs processing for solving the malfunction based on the transmitted information, and transmits a result thereof to the user's computer. Here, the information on the malfunction is, for example, a display error occurring when a browser program displays a specific Web page, error information transmitted from a Web server, or the like.

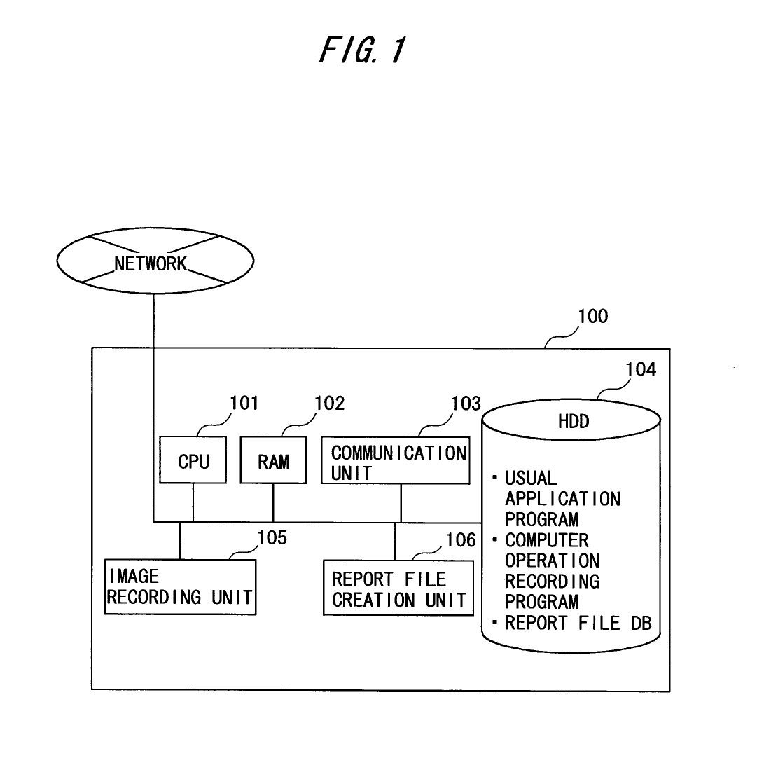

FIG. 1 is a block diagram showing a functional configuration of a computer 100 according to this embodiment. The computer 100 is configured as a personal computer (PC), a personal digital assistant (PDA), or other various computers. Note that, in this embodiment, description is made on the assumption that the computer 100 is mainly the personal computer. The computer 100 includes, as hardware, a control device (composed of a CPU 101, a primary storage (a RAM 102 or the like), an input/output unit, an OS, a device driver, and the like), a secondary storage (hard disk 104 or the like), and a communication control device (network interface device or the like). Then, the CPU 101 loads, onto the primary storage, the computer operation recording program stored in the secondary storage, executes the computer operation recording program there, and thus the computer 100 realizes functions of the computer, which are capable of the computer operation recording processing in the system. Specifically, the computer 100 realizes functions of a communication unit 103, an image recording unit 105, and a report file creation unit 106 by means of the hardware configuration and the computer operation recording program.

The CPU 101 is an operation processing unit mounted on a usual computer. The CPU 101 loads the computer operation recording program from the hard disk 104 onto the RAM 102, and realizes the functions of the image recording unit 105 and the report file creation unit 106. Moreover, the CPU 101 executes the computer operation recording program, and thus realizes the function of the communication unit 103 by use of the communication control device and the like.

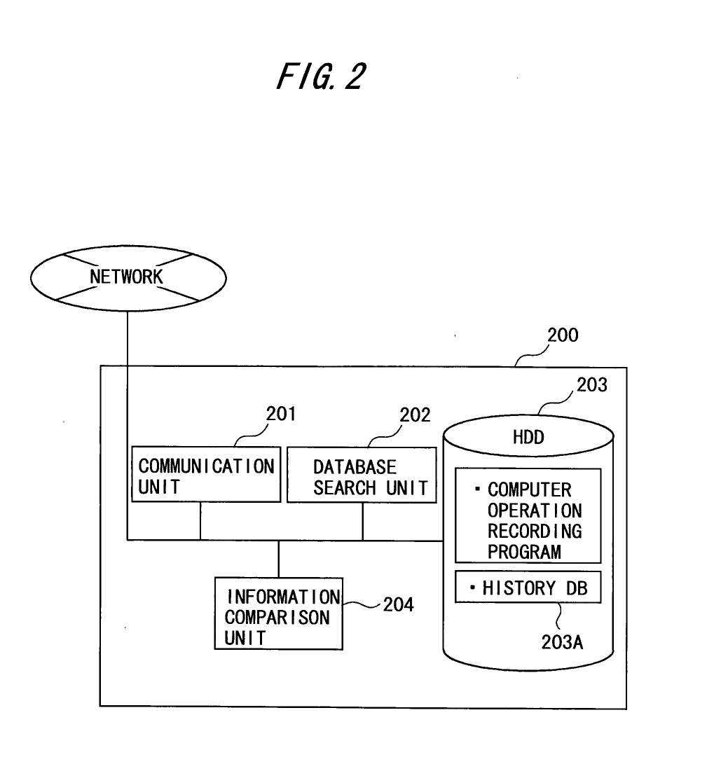

By taking, as a trigger, a predetermined user's operation when the user feels that the malfunction has occurred in usual execution contents of the application program executed by the computer 100, the image recording unit 105 (corresponding to the recording unit) records, as image files, output contents of the application program to a display (not shown) or the like at a predetermined time interval (for example, every 0.1 second). However, the image recording unit 105 may be adapted to record the output contents when the computer 100 determines that the server (for example, a server 200 shown in FIG. 2) on the network cannot normally provide the information or the service when the computer 100 receives provision of the information or the service from the server. In this case, the server may satisfactorily be adapted to transmit a request to activate the image recording unit 105 to the computer 100.

Moreover, the image recording unit 105 configures and records the image files recorded at predetermined time intervals as a motion picture file composed of a video changing sequentially. Possible examples of a format for the motion picture file recorded at this time include an AVI (Audio Video Interleaving) format and MPEG (Moving Picture Experts Group) 2/MPEG 4.

The report file creation unit 106 (corresponding to the report information creating unit) creates a failure report file (corresponding to the report information) which records information relating to the computer 100 or information relating to the application program in which the malfunction has occurred together with the image files or the motion picture file recorded by the image recording unit 105, in which the output contents when the malfunction of the application program of the computer 100 has occurred are recorded.

Possible examples of the information relating to the computer 100, which is included in the failure report file, include information specifying the type of the computer 100 (model number, serial number, and the like of the computer 100), information specifying the type and performance of the CPU 101, information indicating a hardware configuration of the computer 100, information of the type and version of the operating system (OS) introduced into the computer 100, and control parameters set in the operating system.

Moreover, possible examples of the information relating to the application program included in the failure report file include a name of the application program, version information on the application program, and a type of a patch file applied thereto.

The communication unit 103 (corresponding to the transmitting unit and the receiving unit) accesses other computers (server 200 in FIG. 2, and the like) on the network such as the Internet through the network. Here, the communication unit 103 transmits the failure report file created by the report file creation unit 106 to the server 200. Moreover, the communication unit 103 receives a response file (corresponding to the response information) responded by the server 200 as a countermeasure procedure against the failure specified by the failure report file. Furthermore, the communication unit 103 transmits, to the server 200, result information as to whether or not the malfunction which has occurred in the computer 100 has been solved by executing contents of the response file.

FIG. 2 is a block diagram showing a functional configuration of the server 200 according to this embodiment. The server 200 is configured by use of various computers such as a personal computer (PC), a general-purpose server, and other dedicated computers (for example, a database server and a Web server). Note that, in this embodiment, description is made on the assumption that the server 200 is mainly the general-purpose server. The server 200 includes, as hardware (not shown), a control device (composed of a CPU, a primary storage (RAM or the like), an input/output unit, an OS, a device driver, and the like), a secondary storage (hard disk 203 or the like), and a communication control device (network interface device or the like). Then, the server 200 loads, onto the primary storage, the computer operation solving program stored in the secondary storage, executes the computer operation solving program there, and thus the CPU realizes functions of the computer, which are capable of the computer operation solving processing in the system. Specifically, the server 200 executes the computer operation solving program, and thus realizes functions of a communication unit 201, a database search unit 202, an information comparison unit 204, and a failure report database 203A in the hard disk device 203.

The communication unit 201 (corresponding to the receiving unit and the transmitting unit) receives the failure report file transmitted from the computer 100. Moreover, the communication unit 201 transmits, to the computer 100, the response file including information on the countermeasure against the failure of the application program, which is stored in the failure report file.

The database search unit 202 searches a past malfunction solving case stored in the failure report database 203A based on the image or motion picture information indicating the malfunction of the application program, the information relating to the computer 100, and the information relating to the application program, which are included in the failure report file received by the communication unit 201.

The information comparison unit 204 compares the image or motion picture information indicating the malfunction of the application program, which is included in the past malfunction solving case, with the image or motion picture information of the failure report file, and determines whether or not it is appropriate to provide the former image or motion picture information as the past malfunction solving case to the user. At this time, the information comparison unit 204 extracts feature information of the respective image or motion picture information (for example, a shape (line segments or bit pattern) constituting the image, transition state of coloration and display state of the image, and the like). Then, when a degree of coincidence of the respective feature information is a predetermined ratio or more, the information comparison unit 204 transmits the solving case to the computer 100 in order to provide the solving case as the response file to the user.

Moreover, when there is none corresponding to the failure report file in the past malfunction solving cases as a result of the comparison, the information comparison unit 204 urges a support person of the maker to handle the failure (the database search unit 202 and the information comparison unit 204 correspond to the searching unit). In this embodiment, in this case, the support person of the maker creates the response file for the failure in the failure report file. In this embodiment, the response file is, for example, information including a motion picture which explains the countermeasure against the failure.

<Processing Example of Failure Report>

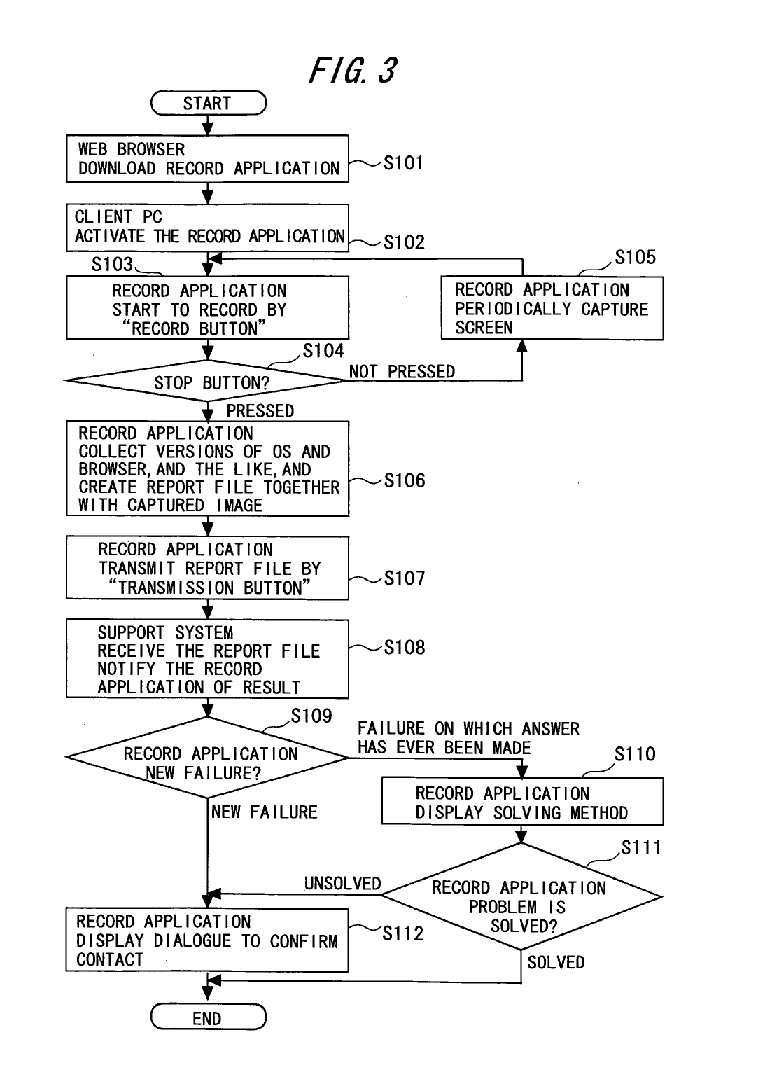

FIG. 3 is a flowchart showing processing of the failure report by a malfunction solving system realized by the computer 100 and the server 200. Note that, in the following processing example, description is given of an example of solving a malfunction occurring when a predetermined Web page is browsed by means of a Web browser application program on the computer 100.

First, the user of the computer 100 downloads the computer operation recording program (hereinafter, a record application) from a Web site on the maker's side by use of the Web browser application program (S101). When the malfunction occurs in the application program, the record application of the computer 100 is activated (S102).

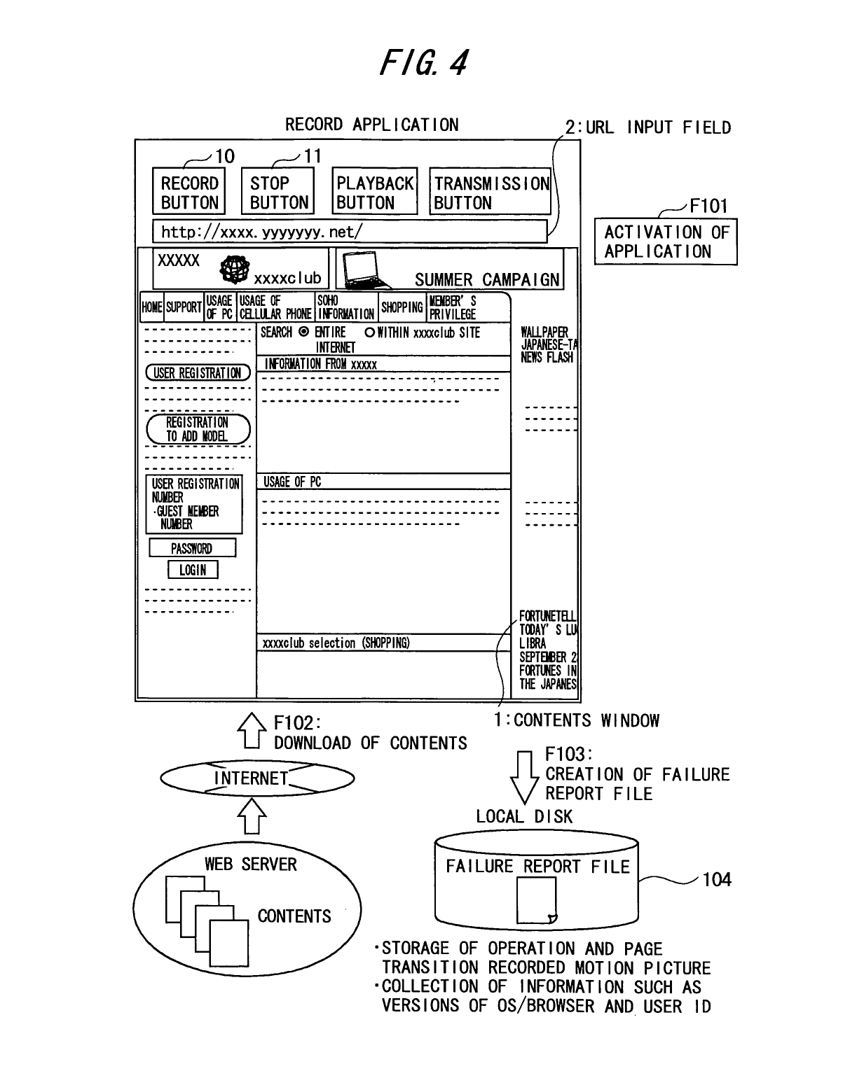

FIG. 4 is a view showing a creation process of the failure report file according to this embodiment. First, when the user encounters a trouble when browsing a Web page, the record application is activated (F101 of FIG. 4). At this time, when an error of the browser is detected on the Web site, it is satisfactory that a Web server transmits error occurrence information to the browser and urges the user to activate the record application by means of a predetermined message. Moreover, in other case than this, that is, in a case where the error is other than the error detected on the Web site, it is satisfactory to guide the user to activate the record application with error occurrence information of the application program itself as a trigger. After the activation, the record application stores user's operation contents/page transition as a motion picture.

This record application is realizable not only in a mode of a usual application but also in a mode of an embedded program such as Java (registered trademark) applet/ActiveX. In this processing example, the record application is explained as the usual application. This record application includes a communication function with the server 200.

Simultaneously with the activation, the record application opens the Web page where the failure has occurred on a contents window 1 provided in this record application. The contents window 1 is an embedded-type browser for displaying the Web page in the record application. Embedding of such a browser into a specific application program can be realized by a group of functions (referred to as IE components in Internet Explorer that is a browser of Microsoft Corp. in the U.S.A.) which provides constituent elements of the existing Web browser program as parts. Moreover, on the record application, a URL input field 2 is also displayed so as to make it possible to confirm the Web page transition.

According to guidance of the record application, the user operates an inside of the embedded-type browser, and downloads contents of the browsed Web page in order to perform an operation to cause the same trouble again (F102 of FIG. 4).

The user presses a record button 10 on the record application, and thus recording (also referred to as capturing) of the image is started (S103). When performing the capturing of the image, the record application checks whether or not an operation of a stop button 11 to stop the recording of the image or motion picture information has been performed by the user (S104). When the operation of the stop button 11 is not performed, the record application periodically captures the images of the contents window 1, and records the images in the hard disk 104 (S105).

When the stop button 11 on the record application is operated after the occurrence of the failure has been replicated by the user, the record application stops capturing the image. The record application determines that the recording of the images to be stored in the failure report file is completed at this point of time, and starts converting the image data into a motion picture.

The record application creates the motion picture file based on the captured images. Moreover, the record application creates the failure report file including the information (user ID, version of the OS, hardware configuration information, control parameters of the OS, and the like) relating to the computer 100 and information (version of the browser application program and the like) relating to the application program together with the image or motion picture file (S106, F103 of FIG. 4). The created failure report file is stored in a failure report file database in the hard disk device 104 of the computer 100.

Note that, possible examples of a method of converting a sequence of the still images into the motion picture in the record application include “non-compressed AVI” which only makes simple BMP (Bit Map) images continue in the time-series direction. Moreover, possible examples of another method of creating the motion picture include the existing technology such as “Motion JPEG” which converts the captured still images into JPEG (Joint Photographic Experts Group) compressed images and makes the JPEG compressed images continue in the time-series direction. Furthermore, possible examples of still another method of creating the motion picture include a method involving further compressing these images by use of a technology such as “MPEG2/MPEG4” in order to compress the images to a transmittable size.

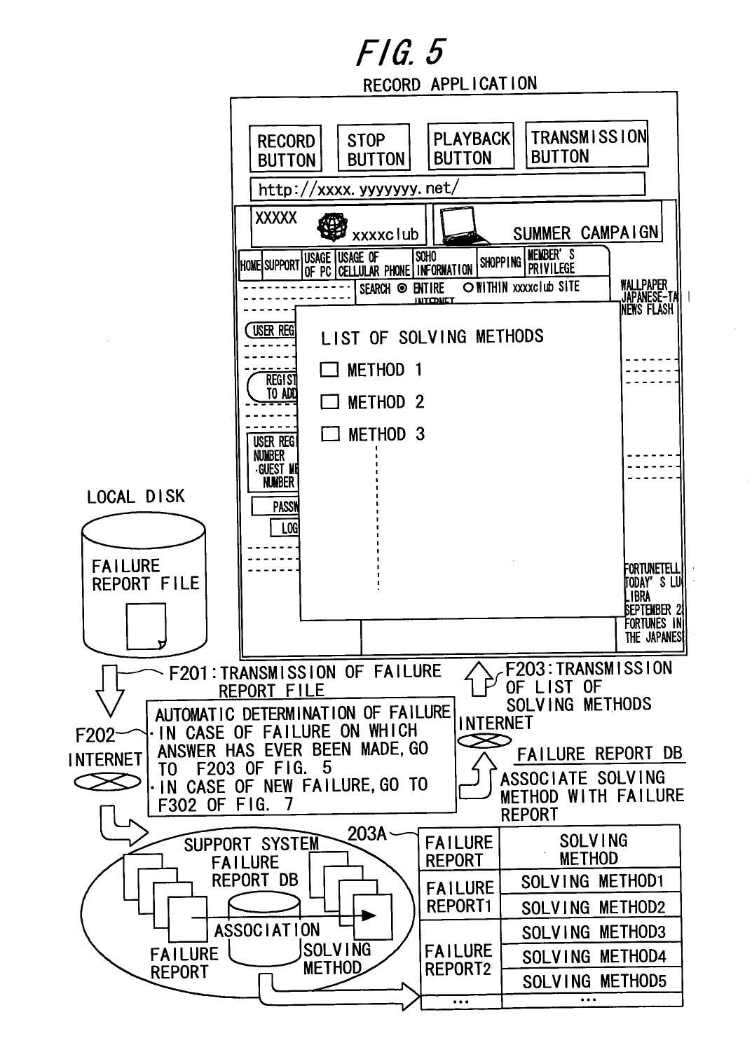

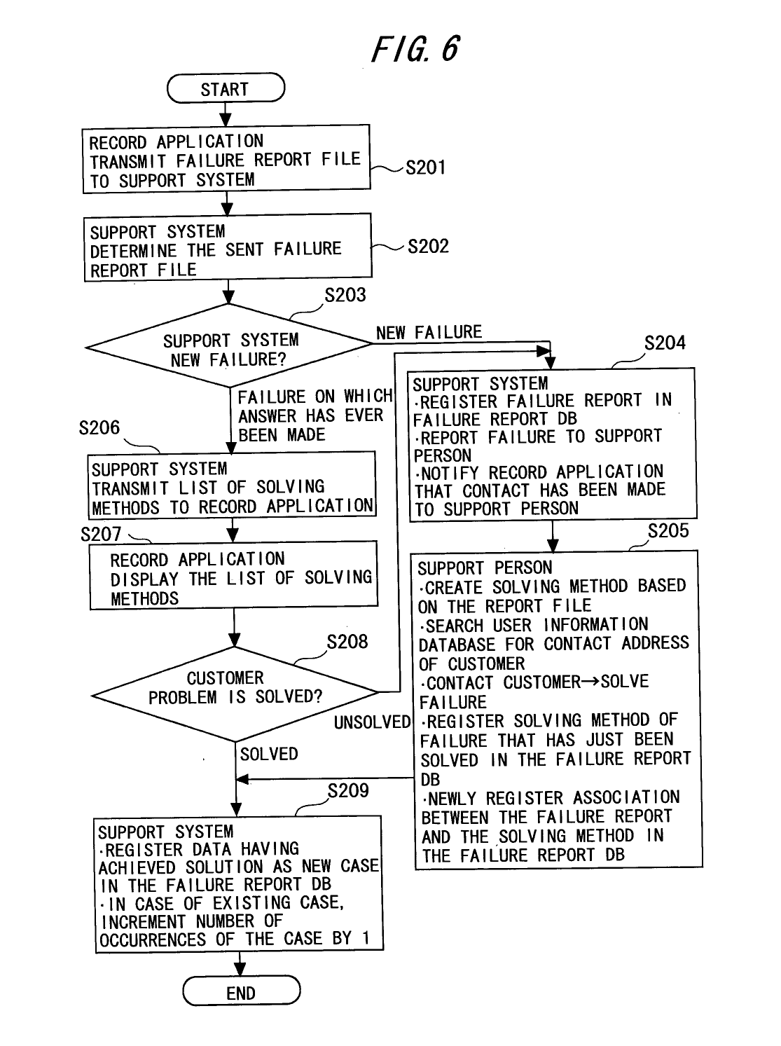

FIG. 5 is a view showing an example of processing for failure reports to a support system on the maker's side managing the server 200 according to this embodiment. FIG. 6 is a flowchart showing processing for failure solution by the malfunction solving system realized by the computer and the server.

The record application connects through the communication unit 103 to a destination to which the support system is connected, which is registered in the program. After the connection, the record application transmits the motion picture file and the other collected information as the failure report file to the server 200 (hereinafter, the support system) (S107 of FIG. 3, S201 of FIG. 6, F201 of FIG. 5).

The support system stores the transmitted failure report file in the hard disk device 203. After that, the support system searches the failure report database 203A in which history information regarding the past malfunction solving cases is stored based on the transmitted failure report file (S108, S202). Then, the support system determines whether or not the transmitted failure report file shows a new failure which is not present in the past malfunction solving cases (S109, S203, F202 of FIG. 5).

Applicable examples of a method of determining a degree of coincidence of the transmitted failure report file and the history information include a method involving making a search from the database by use of a publicly known technology (for example, JP 2003-331288 A “Image Determining Apparatus, and Image Determining method”, JP 10 (1998)-320400 A “Method and Apparatus for Searching Video”, or the like) for determining similarity of images.

As shown in FIG. 5, the failure report database 203A has combinations of identification information (failure report 1, failure report 2, and the like) of the failure reports which are the contents of the failure report files and identification information (solving method 1, solving method 2, and the like) of the solving information which are the contents of the response files. The identification information of the failure reports is information identifying the files of the failure reports reported in the past. Note that the report files themselves are identified by the images included in the report files. Moreover, the identification information of the solving information is identification information of information provided as the solving methods in the past. The identification information of the failure reports is linked with the failure report files accumulated in the past. Moreover, the identification information of the solving information is linked with the information (response files) provided as the solving methods in the past.

When newly receiving a report file from the user, the support system determines whether or not an image included in the report file is similar to the image in any of the accumulated failure report files (whether or not the degree of coincidence is within a predetermined range). The degree of coincidence is information indicating an extent of coincidence of two images, and is also referred to as a score in matching processing of the images.

When the degree of coincidence is within the predetermined range, the support system searches the failure report database 203A based on the identification information of the past failure report files thereof, and extracts a list of the solving methods. When the degree of coincidence is not within the predetermined range, the support system adds new identification information to the failure report file, and records the new failure report file in the failure report database 203A.

In such a way, for example, when the malfunction, is one caused by a general operation mistake, the past failure case (failure report file accumulated in the past) previously recorded in the failure report database 203A and the transmitted failure report file are compared with each other, thus making it possible to determine that the failure report file shows a trouble similar to that in the past failure case. Therefore, the support system transmits, as the response file, the past malfunction solving case associated with the transmitted failure report file.

When the failure report file is similar to the malfunction solving case on which an answer has ever been made, the support system transmits a motion picture list (information which lists the motion pictures indicating the solving methods) which describes the solving cases stored in the database to the computer 100 (S206, F203 of FIG. 5). The computer 100 displays the list of the solving cases in the transmitted response files on the display (S110, S207). The user selects an appropriate motion picture from the motion picture list, thus making it possible to refer to the solving method as the motion picture.

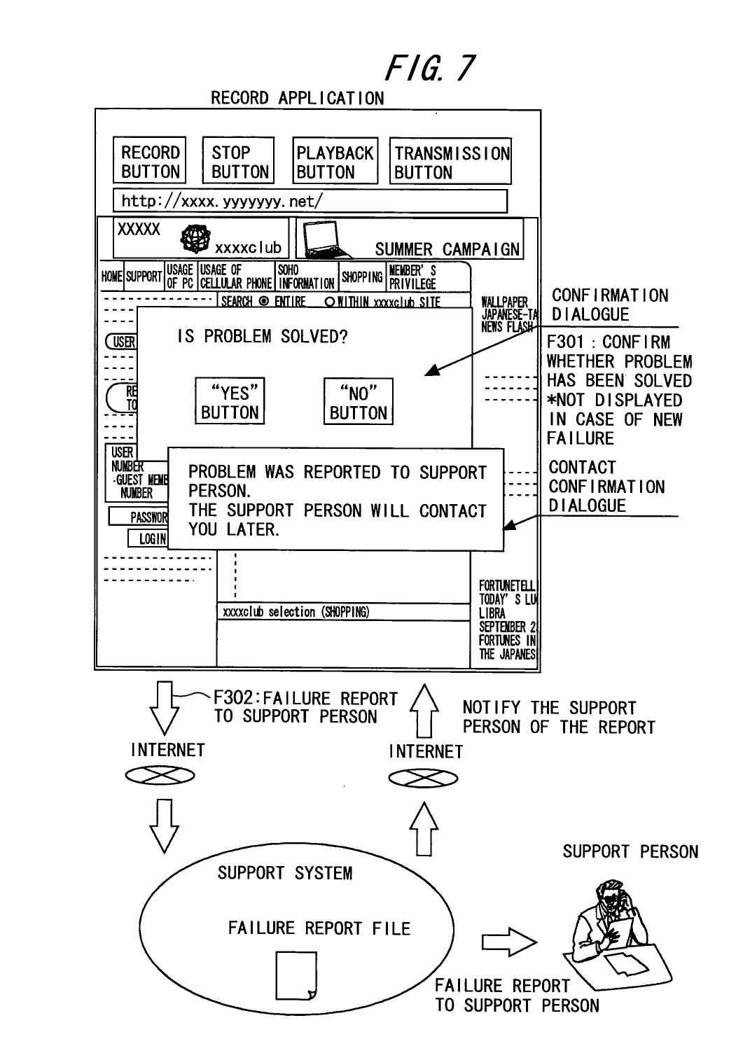

FIG. 7 is a view showing an example of reporting processing to the person in charge of the support system after the transmission of the malfunction solving case to the computer 100. When the list of the solving cases is transmitted, a dialog box for confirming whether or not the problem has been solved is displayed on the display of the computer 100 (S111, S208, F301 of FIG. 7). When the user answers to the dialog box, the answer is transmitted from the computer 100 to the support system. Thus, the support system can know whether or not the malfunction in the user has been solved by the transmitted solving cases. The support system may update the information of the failure report database 203A according to the answer. For example, when the problem has not been solved, the combination of the identification information of the failure report and the identification information of the solving information may satisfactorily be deleted from the failure report database 203A.

Specifically, when the user answers that the problem has not been solved even if the motion picture included in the response file has been browsed, or when there has not been a candidate in the failure report database 203A, a malfunction of the failure report file is determined to have a new failure. In such a case, the support system regards the failure report file as having a new failure, adds the identification information to the failure report file, and registers the failure report file in the failure report database 203A. Moreover, the support system notifies the support person of the report file of the new failure (S204, F302 of FIG. 7). Furthermore, the support system notifies the computer 100 that the transmitted failure report file has already been reported to the support person (S112).

When the solution of the failure is finally reported from the user, the support system combines the identification information of the transmitted failure report and the identification information of the solving information indicating the solving method corresponding to the failure report file, and registers the combined information as a new solving case in the failure report database 203A. In this case, when the support system can make the solution with reference to the list of the existing solving cases, the support system registers such a case as a new case in the data of the solving cases (S209).

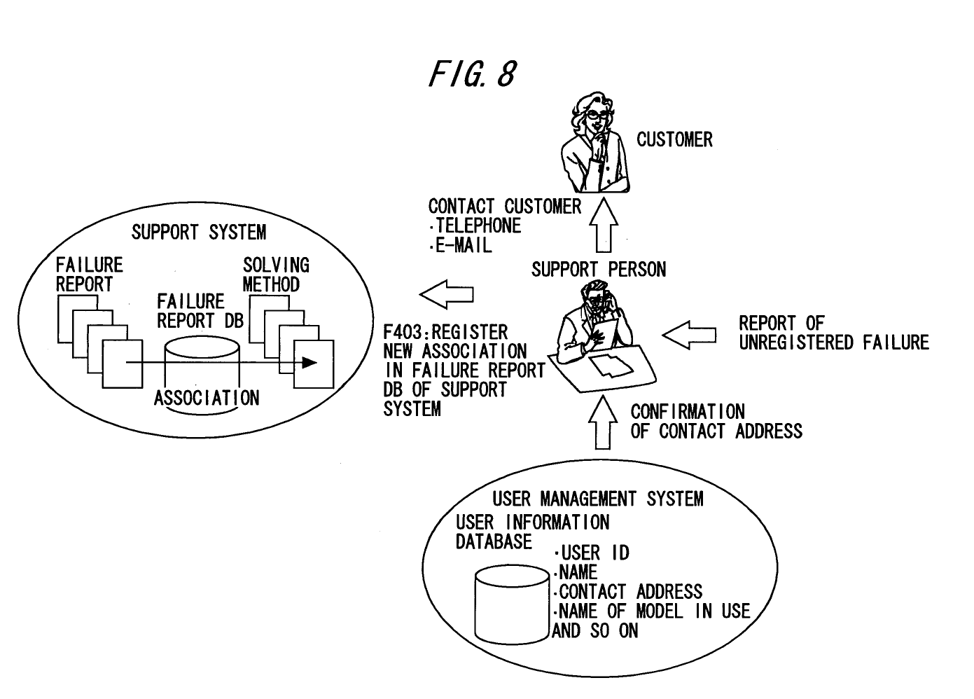

FIG. 8 is a view showing an example of response file creation processing by the support person for the new failure according to the system. The support person having received a new failure report file (one to which the identification information is newly added) which is not registered in the failure report database 203A plans the countermeasure procedure based on the image and motion picture of the failure report file, the information regarding the computer, or the information regarding the application program, and registers the response file including the solving information. The countermeasure information is expressed by, for example, the motion picture. When the countermeasure information is registered, the countermeasure information is added with the identification information, combined with the identification information of the failure report, and registered in the failure report database 203A (F403).

In this case, the support system may satisfactorily be adapted to search a contact address of the user in which the new failure has occurred, and to notify the user that the countermeasure information has been newly added to the failure report database 203A. The user may satisfactorily be adapted to transmit the failure report file again from the record application, and to acquire the countermeasure information.

### MODIFICATION EXAMPLE

The malfunction solving system composed of the computer 100 and the server 200 according to this embodiment is not limited to the processing example described above, and for example, may perform processing as below.

For example, in the case where the computer 100 is provided with the record application as an embedded type to the browser application, such as ActiveX, the server 200 may instruct the computer 100 to activate the record application when the server 200 detects an error. Then, in this case, when transferring an error page to the server 200, the record application acquires header information of an html page immediately before the error page. The page immediately before the page in which the error has actually occurred is given as a parameter of an ActiveX component by information of HTTP#REFERER and the like, and thus the server 200 can open the page in which the error has occurred simultaneously with display of the error page. Accordingly, the server 200 can immediately display the Web page causing the failure.

Moreover, in this embodiment, as a method of comparing the failure report file and the past malfunction solving case with each other, it is also possible for the support person to make a visual determination by comparing the transmitted motion picture and the motion picture of the failure case, which has already been registered, with each other.

### Effect of Embodiment

According to the malfunction solving system described above and composed of the computer 100 and the server 200, which is an embodiment of the present invention, effects as below can be obtained.

According to the system, the trouble solving method database can be automatically enriched for the malfunctions of the application programs, which have occurred in the computer 100. Moreover, according to the system, accuracy with which the solving method is instantaneously submitted to the user can be improved. Furthermore, according to the system, the support person can reduce an operation time in the case of coping with the same trouble.

Furthermore, according to the system, it becomes satisfactory that the support person mainly handle new troubles, and accordingly, entire labor required for support work can be reduced.

<Computer-Readable Recording Medium>

A program for causing a computer and other machines and apparatuses (hereinafter, computer and the like) to realize any of the functions can be recorded in a recording medium readable by the computer and the like. Then, the computer and the like are caused to read and execute the program in the recording medium, thus making it possible to provide the functions.

Here, the recording medium readable by the computer and the like refers to a recording medium in which information such as data or a program is accumulated by an electrical, magnetic, optical, mechanical, or chemical function and readable by the computer and the like. Examples of recording media detachable from the computer and the like among such recording media include a flexible disk, a magneto-optical disc, a CD-ROM, a CD-RW, a DVD, a DAT, an 8-mm tape, and a memory card. Moreover, examples of recording media fixed to the computer and the like include a hard disk and a ROM.

As described above, according to the present invention, assistance can be performed such that the malfunction which has occurred in the computer is solved rapidly and surely.

What is claimed is:

1. A computer operation recording program for causing a computer to execute the steps of:
recording image information of a display screen, which is outputted from the computer, at a predetermined time interval in accordance with a predetermined user's operation when a malfunction occurs in the computer taken as a trigger;
creating report information which includes the image information and reports the malfunction;
transmitting the report information to a management apparatus; and
receiving, from the management apparatus, response information in which information on a countermeasure against the malfunction reported by the report information is stored.

2. A computer operation recording program according to claim 1, further causing the computer to execute the step of creating motion picture information from a start of recording to an end of the recording based on the image information, wherein the motion picture information is stored in the report information.

3. A computer operation recording program according to claim 1, wherein the report information includes information relating to the computer; and
the information relating to the computer includes information specifying a model of the computer, information specifying performance of the computer, information controlling an operating state of the computer, or information specifying an operating system introduced into the computer.

4. A computer operation recording program according to claim 1, wherein the report information includes information relating to an application program executed by the computer; and
the information relating to the application program includes a name of the application program or version information on the application program.

5. A computer operation recording program according to claim 1, further causing the computer to execute the step of transmitting, to the management apparatus, result information as to whether or not the malfunction has been solved as a result of application of the countermeasure.

6. A computer operation solving program for causing a computer to execute the steps of:
receiving, from a user's computer on a network, report information reporting a malfunction which has occurred in the user's computer;
searching a report database, which stores the past report information and information of a countermeasure against the contents of the report reported in the past report information, for past report information similar to contents of the report information; and
transmitting, to the user's computer, the information on the countermeasure against the past report information retrieved from the report database.

7. A computer operation solving program according to claim 6, wherein the report information includes image information relating to the malfunction, the computer operation solving program further causing the computer to execute the steps of:
calculating a degree of coincidence indicating an extent of coincidence by comparing the image information stored in the report information and image information in the past report information stored in the report database with each other; and
extracting past report information in which the degree of coincidence satisfies a predetermined range.

8. A computer, comprising:
a recording unit recording image information of a display screen, which is outputted from the computer, at a predetermined time interval in accordance with a predetermined user's operation when a malfunction occurs in the computer taken as a trigger;
a report information creating unit creating report information which includes the image information and reports the malfunction;
a transmitting unit transmitting the report information to a management apparatus; and
a receiving unit receiving, from the management apparatus, response information in which information on a countermeasure against the malfunction reported by the report information is stored.

9. A computer according to claim 8, further comprising a creating unit creating motion picture information from a start of recording to an end of the recording based on the image information, wherein the motion picture information is stored in the report information.

10. A computer according to claim 8, wherein the report information includes information relating to the computer; and
the information relating to the computer includes information specifying a model of the computer, information specifying performance of the computer, or information specifying an operating system introduced into the computer.

11. A computer according to claim 8, wherein the report information includes information relating to the computer, and wherein the information relating to the application program includes a name of the application program or version information on the application program.

12. A computer according to claim 8, further comprising a transmitting unit transmitting, to the management apparatus, result information as to whether or not the malfunction has been solved as a result of application of the countermeasure.

13. A management apparatus, comprising:
a receiving unit receiving, from a user's computer on a network, report information reporting a malfunction which has occurred in the user's computer;
a searching unit searching a report database, which stores the past report information and information of a countermeasure against the contents of the report reported in the past report information, for past report information similar to contents of the report information and
a transmitting unit transmitting, to the user's computer, the information on the countermeasure against the past report information retrieved from the report database.

14. A management apparatus according to claim 13, wherein the report information includes image information relating to the malfunction, and the management apparatus further comprising:
a calculating unit calculating a degree of coincidence indicating an extent of coincidence by comparing the image information stored in the report information and image information in the past report information stored in the report database with each other; and
an extracting unit extracting past report information in which the degree of coincidence satisfies a predetermined range.

15. A computer operation solving method, comprising the steps of:
receiving, from a user's computer on a network, report information reporting a malfunction which has occurred in the user's computer;
searching a report database, which stores the past report information and information of a countermeasure against the contents of the report reported in the past report information, for past report information similar to contents of the report information; and
transmitting, to the user's computer, the information on the countermeasure against the past report information retrieved from the report database.

16. A computer operation solving method according to claim 15, wherein the report information includes image information relating to the malfunction, the computer operation solving program further comprising the steps of:
calculating a degree of coincidence indicating an extent of coincidence by comparing the image information stored in the report information and image information in the past report information stored in the report database with each other; and
extracting past report information in which the degree of coincidence satisfies a predetermined range.
